(19) United States
(12) Patent Application Publication
(10) Pub. No.: US 2009/0245836 A1
(43) Pub. Date: Oct. 1, 2009

(54) Belt Fixing Device and Image Forming Apparatus

(75) Inventor: Makoto SATO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/407,533

(22) Filed: Mar. 19, 2009

(30) Foreign Application Priority Data
Mar. 27, 2008 (JP) 2008-082295

(51) Int. Cl. G03G 15/20

(52) U.S. Cl. 399/68

(57) ABSTRACT

A belt fixing device includes a fixing roller, a heating roller, a fixing belt stretched between the fixing roller and the heating roller, a pressing roller pressing the fixing roller through the fixing belt, and a temperature detection unit detecting the surface temperature of the fixing belt. In at least one end portion of the heating roller in an axial direction, a ring regulating skewed movement of the fixing belt toward an axial end, and a belt tension adjusting unit adjusting tension of the fixing belt are provided. The temperature detected by the temperature detection unit is stored in a storage unit. When the belt tension adjusting unit releases belt tension, a control unit controls a rotation stop position of the fixing belt on the basis of the belt temperature stored in the storage unit.

### BACKGROUND

1. Technical Field

The invention relates to a belt fixing device, which can prevent an end portion of a belt from being damaged, and an image forming apparatus.

2. Related Art

Electrophotographic image forming apparatuses use a belt fixing device as a fixing device for a transfer medium. In such a belt fixing device, a belt is a thin endless belt that is manufactured by coating silicon rubber on a base material, such as stainless steel, nickel, or the like, and forming a heat-resistant release layer having good heat resistance and releasability against toner.

In the belt fixing device, a measure to prevent a fixing belt from being damaged becomes an issue. For example, Japanese Patent No. 3,711,717 discloses a configuration in which an abutting type ring against skewed movement of a fixing belt is provided at one axial end of a tension roller, which gives tension to a fixing roller. In this example, the amount of thermal expansion of the fixing belt is smaller than that of the tension roller (heating roller) on which the ring is provided.

In the configuration of Japanese Patent No. 3,711,717, during cooling, the amount of thermal contraction of the heating roller becomes larger than that of the fixing belt. Accordingly, a guide ring strongly presses the end portion of the fixing belt in an axial direction of the heating roller. Although the fixing belt is pressed in the axial direction of the heating roller by the guide ring, it cannot be easily “shifted” in the axial direction due to a frictional force between the fixing belt and the heating roller. For this reason, large stress is applied to the end portion of the fixing belt, and accordingly ruffles (wrinkles) may be formed in the fixing belt. When this happens, if the heating roller is driven again, two ruffles that are formed in the fixing belt are moved and connected to each other. As a result, the fixing belt may be damaged (cracked). In addition, in a state where the fixing belt is shaped due to creep caused by heat of the heating roller and tension of the tension roller, if a small-curvature portion approaches an engagement start portion, the generation position of the ruffle (wrinkle) in the fixing belt is close to an end portion bend of the fixing belt, and two ruffles are connected to each other. As a result, the fixing belt is likely to be damaged (cracked).

In order to reduce the frictional force between the fixing belt and the heating roller, it is effective to coat the heating roller with fluorine or to decrease tension of the fixing belt. However, in order to stably drive the fixing belt crept by fixing heat, predetermined tension needs to be applied, and actually the above-described measure has an insufficient effect.

### SUMMARY

An advantage of some aspects of the invention is that it provides a belt fixing device, which can prevent an end portion of a fixing belt from being damaged, and an image forming apparatus.

According to an aspect of the invention, a belt fixing device includes a fixing roller, a heating roller, a fixing belt stretched between the fixing roller and the heating roller, a pressing roller pressing the fixing roller through the fixing belt, and a temperature detection unit detecting the surface temperature of the fixing belt. In at least one end portion of the heating roller in an axial direction, a ring regulating skewed movement of the fixing belt toward an axial end, and a belt tension adjusting unit adjusting tension of the fixing belt are provided. The temperature detected by the temperature detection unit is stored in a storage unit. When the belt tension adjusting unit releases belt tension, a control unit controls a rotation stop position of the fixing belt on the basis of the belt temperature stored in the storage unit.

In the belt fixing device according to the aspect of the invention, the belt tension adjusting unit may adjust a distance between the axis of the fixing roller and the axis of the heating roller by an electromagnetic driving unit and a spring unit.

In the belt fixing device according to the aspect of the invention, control may be performed such that a small-curvature portion of the fixing belt may stop at a position out of an engagement start portion of the heating roller.

In the belt fixing device according to the aspect of the invention, in a state where the belt tension adjusting unit releases belt tension, the fixing belt may maintain an ellipse when being stretched between the fixing roller and the heating roller due to thermal deformation, and small-curvature portions of the fixing belt may be formed by arcs along a major axis of the ellipse.

In the belt fixing device according to the aspect of the invention, the rotation stop position of the fixing belt may be a position when tension is given to the fixing belt again after tension is released, and the fixing belt is moved from the position of the fixing belt at the time of tension release by a length of the fixing belt wound around the heating roller.

In the belt fixing device according to the aspect of the invention, a timing to detect the state of thermal deformation of the fixing belt to control the stop position of the fixing belt may be set to be when a high-temperature rotation time during a job immediately before the fixing belt stops is equal to or less than a predetermined time.

In the belt fixing device according to the aspect of the invention, a timing to detect the state of thermal deformation of the fixing belt to control the stop position of the fixing belt may be set to be when the sum of a high-temperature rotation time during a job immediately before the fixing belt stops and a stop time until a job starts is equal to or less than a predetermined time.

According to another aspect of the invention, an image forming apparatus image forming units each having at least one of a charging unit, an exposure unit, a developing unit, and a transfer unit around a photosensitive member, and the belt fixing device according to the aspect of the invention. The image forming apparatus transfers an image formed on each of the image forming units to a recording medium, thereby performing image formation.

### BRIEF DESCRIPTION OF THE DRAWINGS

The invention will be described with reference to the accompanying drawings, wherein like numbers reference like elements.

FIG. 1 is a flowchart illustrating an embodiment of the invention.

FIG. 2 is a flowchart illustrating an embodiment of the invention.

FIG. 3 is a characteristic diagram illustrating an embodiment of the invention.

FIG. 4 is a characteristic diagram illustrating an embodiment of the invention.

FIGS. 5A to 5D are explanatory views illustrating an embodiment of the invention.

FIG. 6 is an explanatory view illustrating an embodiment of the invention.

FIG. 7 is an explanatory view illustrating an embodiment of the invention.

FIGS. 8A and 8B are explanatory views illustrating an embodiment of the invention.

FIGS. 9A and 9B are explanatory views illustrating an embodiment of the invention.

FIG. 10 is an explanatory view illustrating an embodiment of the invention.

FIG. 11 is an explanatory view illustrating an embodiment of the invention.

FIG. 12 is a characteristic diagram illustrating an embodiment of the invention.

FIG. 13 is an explanatory view illustrating an embodiment of the invention.

FIG. 14 is an explanatory view illustrating an embodiment of the invention.

FIG. 15 is a characteristic diagram illustrating an embodiment of the invention.

FIG. 16 is an explanatory view illustrating an embodiment of the invention.

FIG. 17 is an explanatory view illustrating an embodiment of the invention.

FIG. 18 is a block diagram illustrating an embodiment of the invention.

FIG. 19 is schematic sectional view illustrating the overall configuration of an example of an image forming apparatus using an electrophotography process according to the invention.

### DESCRIPTION OF EXEMPLARY EMBODIMENTS

An embodiment of the invention will be described with reference to the drawings. FIG. 10 is an explanatory view illustrating an example of a belt fixing device. In FIG. 10, a fixing belt 34 is stretched between a fixing roller 31 and a heating roller 35, which function as belt tension rollers. A fixing heater 36 is provided inside the heating roller 35. The temperature of the fixing belt 34 is detected by using a temperature detection device 37, such as a thermistor. The fixing heater 36 serving as a heat source is turned on/off on the basis of the detection result of the temperature detection device 37, to thereby perform temperature control of the heating roller 35 that should be maintained at a desired temperature.

As the fixing heater 36, for example, a halogen lamp is used. An overheating prevention device 38 is provided near the heating roller 35 to prevent fire when abnormality is produced. The heating roller 35 is given a pressing force Ft by a belt tension spring 33a to apply tension to the fixing belt 34. The pressing roller 32 is given a pressing force Fp by a pressing spring 33.

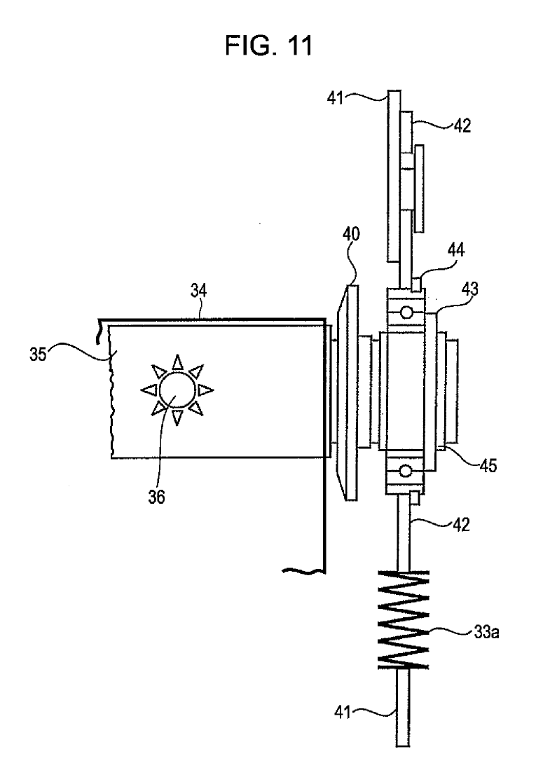

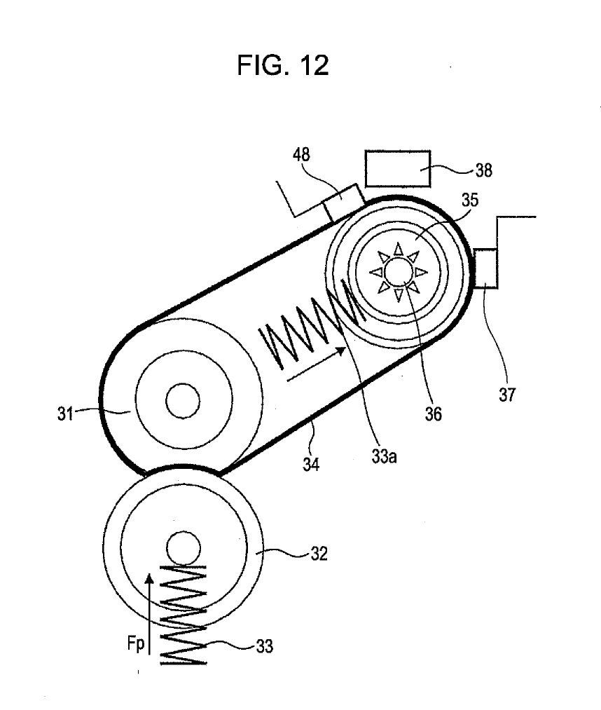

FIG. 11 is an explanatory view illustrating a fixing method of the heating roller 35 and the fixing belt 34 to a fixing unit in the belt fixing device. In FIG. 11, a bearing 44 fixing the heating roller 35 is inserted into a tension plate 42, and the tension plate 42 is fixed to be movable in one direction with respect to a fixing frame 41. The tension plate 42 is urged in one direction by the belt tension spring 33a, one end of which is fixed to the fixing frame 41. With this configurations the fixing belt 34 is stretched between the heating roller 35 and the fixing roller 31 under substantially uniform tension.

The bearing 44 has sealed grease in terms of heat resistance, and since the surface temperature of the heating roller 35 reaches an extremely high temperature, it is inserted into a rotational shaft (flange) of the heating roller 35 through a heat-insulating bush 43. A guide ring 40 is designed so as to be rotatable and movable in a thrust direction in at least one end portion of the heating roller 35 toward the rotational shaft, that is, so as to be spaced from the rotational shaft of the heating roller 35. The guide ring 40 functions as a ring regulating skewed movement of the fixing belt 34 toward an axial end of the heating roller 35.

Respective members of the belt fixing device will be further described in detail. As described with reference to FIG. 10, the fixing belt 34 is stretched between the fixing roller 31, which is positioned in the fixing unit, and the heating roller 35, which is urged to be movable in a predetermined direction by the belt tension spring 33a. In terms of the belt layout, an intermediate roller may be provided between the fixing roller 31 and the heating roller 35, and the fixing belt 34 may be stretched around three or more rollers.

The fixing roller 31 is configured to have a large heat capacity in order to ensure a nip width. A heat source is provided in the heating roller 35 having a small heat capacity and heat is transferred to the fixing roller 31 through the fixing belt 34, thereby reducing a warm-up time. In the example of FIG. 10, the heating roller 35 has the internal fixing heater 36 serving as a heat source, but an electromagnetic induction heating (IH) type heat source may be provided inside and outside the heating roller 35.

The pressing roller 32 is pressed against the fixing roller 31 by the pressing spring 33 with the fixing belt 34 sandwiched therebetween. The pressing roller 32 and the fixing roller 31 are formed of elastic members, and a nip is formed. In the example of FIG. 10, with respect to hardness of the members, the relationship is established that the pressing roller has hardness larger than that of the fixing roller, and, as shown in FIG. 10, a downward nip is formed. In a high-speed machine, a heat source may be provided in the fixing roller 31 or the pressing roller 32. With respect to drive input, in many cases, the fixing roller 31 is connected to the outside through a gear or the like to function as a driving roller, but it may be connected to the pressing roller 32 and driven.

Next, materials of the members to be used for the belt fixing device will be described. In the embodiment of the invention, the fixing belt 34 is a three-layered belt in which an elastic layer made of silicon rubber is formed on an Ni electroformed member, and a release layer made of fluorine resin is further formed. In order to reduce the warm-up time, the heating roller 35 is provided separately from the fixing roller 31. For this reason, it is necessary to transfer heat from the heating roller 35 to the nip portion through the fixing belt 34, and as a base material of the fixing belt 34, a metal belt having a comparatively large heat capacity is used. This is because a resin belt made of polyimide or the like has a small heat capacity, and heat is dissipated to the nip portion, which causes a large heat loss.

The fixing belt 34 has a seamless metal belt, and as described above, Ni electroforming is applied. When a stainless belt from among the metal belts is used, it is necessary to reduce a curvature due to the hardness of the belt, and to increase the diameter of the roller and the size of the fixing device. The elastic layer of the fixing belt is provided in order to increase adhesion to an image surface and to ensure image quality. For the elastic layer, silicon rubber is used because of excellent heat resistance.

In the fixing belt 34, the release layer made of fluorine resin is provided in order to release toner molten in the nip portion from the surface of the belt. As the material of the release layer, perfluoroalkoxy alkane resin (PFA) is used. In the related art, as described in Japanese Patent No. 3,711,717, silicon oil is coated on the elastic layer made of silicon rubber, to thereby ensuring releasability. However, since silicon oil is stuck to the sheet, writability is deteriorated, and in recent years, there is little case in which silicon oil is used.

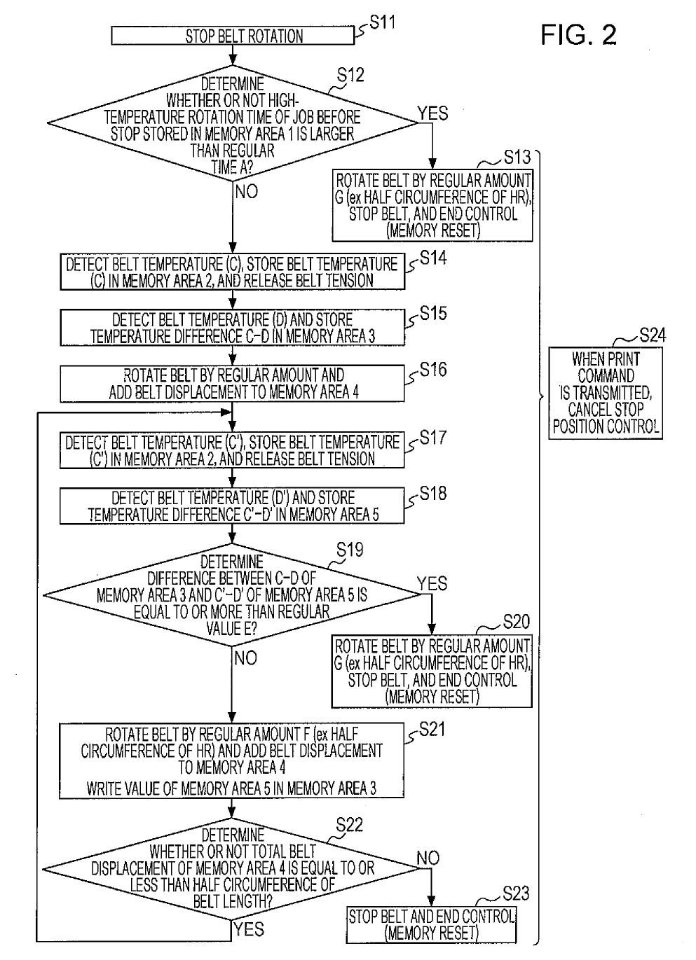

In order to reduce the warm-up time, a thin metal roller having a small heat capacity is used as the heating roller 35. For the thin metal roller, in order to make the temperature distribution in the axial direction uniform, aluminum having high thermal conductivity is used. In order to improve sheet releasability of the image surface, the fixing roller 31 forms a downward nip, as shown in FIG. 2, or a horizontal nip. As the fixing roller 31 that has hardness smaller than that of the pressing roller 32, a sponge roller or the like is used. As the pressing roller 32, in many cases, a rubber roller is used. In terms of heat resistance, for the pressing roller 32, silicon rubber is used. In order to prevent contamination of the rear surface of the sheet and to improve surface releasability, a fluorine resin layer is formed on the surface of the pressing roller 32.

In a normal state, the fixing belt 34 is conveyed between the fixing roller 31 and the heating roller 35 without being skewed in the axial direction of the roller. However, for example, when the two rollers (the fixing roller 31 and the heating roller 35) with the fixing belt 34 stretched therebetween is not in parallel, the fixing belt 34 is skewed in the axial direction of the roller. The fixing belt 34 being skewed rotates at least one tension roller of the fixing roller 31 and the heating roller 35 backward, and the fixing belt 34 moves in an opposite direction to forward rotation.

FIG. 12 is an explanatory view illustrating the embodiment of the invention. The same parts as those shown in FIG. 10 are represented by the same reference numerals, and detailed descriptions thereof will be omitted. In FIG. 12, a sensor 48 is provided to check the surface temperature distribution of the fixing belt 34. An operation to prevent the fixing belt 34 from being damaged due to thermal stress is performed on the basis of the surface temperature distribution of the fixing belt 34 checked by the sensor 48, as described below.

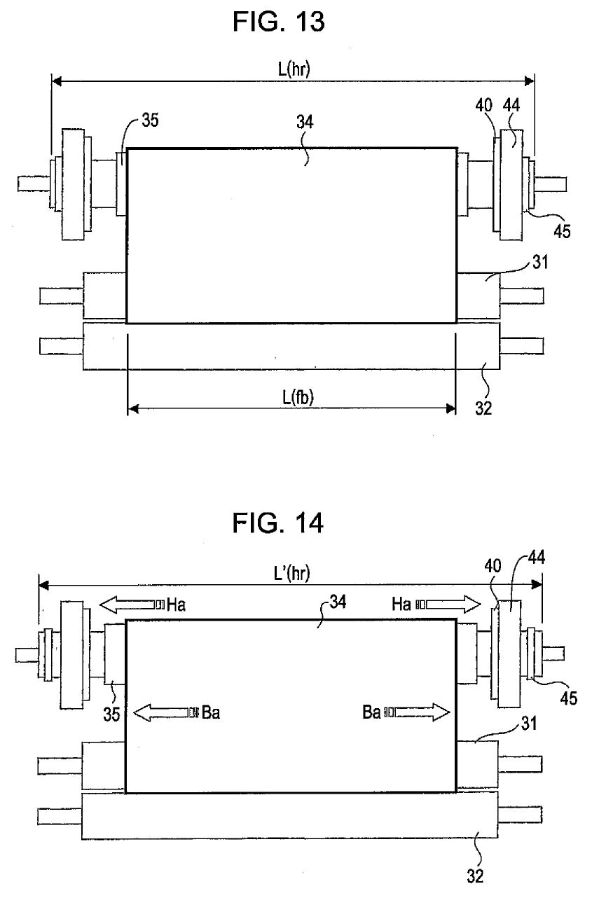

Next, a description will be provided for stress, which is applied to the end portion of the fixing belt 34, with reference to explanatory views of FIGS. 13 to 16. FIG. 13 illustrates the length L(hr) of the heating roller 35 and the length L(fb) of the fixing belt 34 when being cooled. FIG. 14 illustrates the length L′(hr) of the heating roller 35 when being heated. In the configuration of FIGS. 13 and 14, aluminum having high thermal conductivity is used such that the temperature distribution of the heating roller 35 in the axial direction is made uniform when a small size of sheet passes. As the fixing belt 34, an Ni electroformed belt which is maintained at a temperature from a heated portion to the nip portion is used.

If the heater is turned on, the heating roller 35 starts to expand. In FIG. 14, Ha and Ha represent thermal expansion toward both ends of the heating roller 35 in the axial direction. When the heating roller 35 reaches a target temperature, the heating roller 35 is extended by ΔL(hr), and thus the total length of the heating roller 35 is as follows.

L′(hr)=L(hr)+ΔL(hr)

The relationship of the extension amount according to a difference in linear expansion coefficient between the heating roller 35 and the fixing belt 34 will be described. In the embodiment of the invention, stress due to thermal contraction is generated when the following relationship is established with respect to the linear expansion coefficient.

Heating Roller>Fixing Belt

As the heating roller 35 is heated, heat is transferred to the fixing belt 34 wound around the heating roller 35, and the fixing belt 34 starts to thermally expand. In FIG. 14, Ba and Ba represent thermal expansion of the fixing belt 34 toward both ends of the roller. When the fixing belt 34 reaches a target temperature, the fixing belt 34 is extended by ΔL(fb) due to thermal expansion, and thus the total length of the fixing belt 34 is as follows.

L′(fb)=L(fb)+ΔL(fb)

In the configuration of FIG. 14, an example of ΔL(hr) when aluminum is used for the heating roller 35 will be described. Referring to Table 1, the linear expansion coefficient αa of aluminum is 24×10⁻⁶/° C. Let Δt be a difference in temperature of the heating roller 35 between when the heating roller 35 is cooled and when the heating roller 35 is heated. In this case, ΔL(hr) is as follows.

ΔL(hr)=L(hr)×Δt×αa

TABLE 1
Linear Expansion Coefficient by Material (×10⁻⁶/° C.)

| | |
|---|---|
| Aluminum (5000 series) | 24 |
| Iron | 11 |
| Nickel | 15 |
| Si rubber | 25 to 40 |
| PFA | 120 |
| PI | 54 |

Therefore, when the heating roller 35 is heated from 20° C. to 180° C., the following relationship is established.

ΔL(hr)=L(hr)×(180−20)×24×10⁻⁶

Let the linear expansion coefficient be αb, and let the difference in temperature of the heating roller 35 between when the heating roller 35 is cooled and when the heating roller 35 is heated be Δt, then the extension amount ΔL(fb) of the fixing belt 34 is as follows.

ΔL(fb)=L(fb)×Δt×αb

When Ni electroforming is used for the fixing belt 34, since the linear expansion coefficient αb is 15×10⁻⁶/° C. from Table 1, ΔL(fb) is as follows.

ΔL(fb)=L(fb)×(180−20)×15×10⁻⁶

As described above, when L(hr) and L(fb) are the same, the extension amount of the heating roller becomes larger.

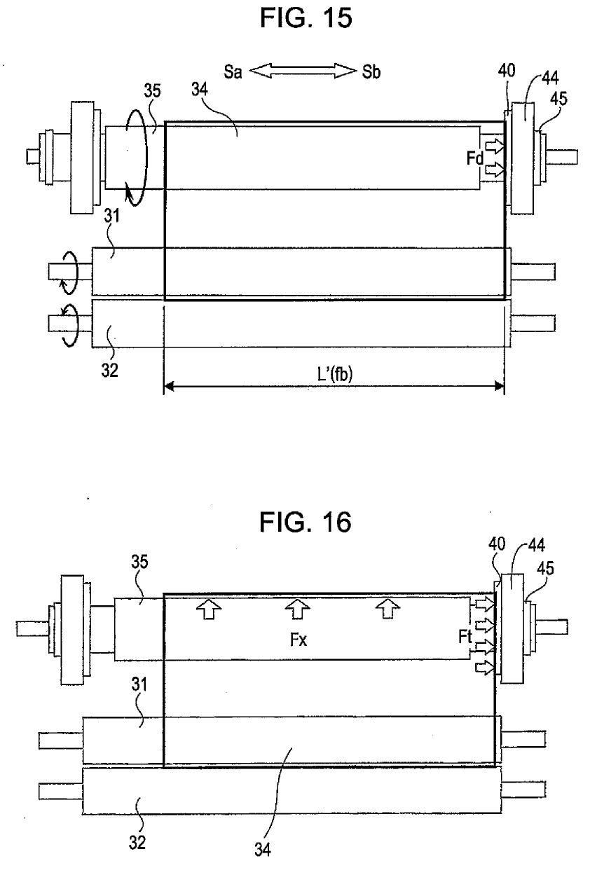

In the belt fixing device, for example, a pair of rollers (in this example, the fixing roller 31 and the heating roller 35 functioning as tension rollers) with the fixing belt 34 stretched therebetween are not in parallel due to a variation in part precision of the fixing frame 41. For this reason, when the tension rollers are rotated, the fixing belt 34 leans in the axial direction of the roller (skewed movement). In FIG. 15, the fixing belt 34 leans in a right direction of the drawing along the axis of the roller. In this case, the same force as the screw rule is applied to the heating roller 35 in contact with the inner surface of the fixing belt 34, and the heating roller 35 leans in a left direction of the drawing along the axis of the roller. Sa denotes the movement direction of the heating roller 35, and Sb denotes the movement direction of the fixing belt 34. As described with reference to FIG. 11, the heating roller 35 is provided in the fixing unit by the bearing 44 so as not to be separated in the axial direction.

The heating roller 35 is configured so as not to move in the axial direction anymore if a snap ring 45, which is provided at the right end of FIG. 15, comes into contact with the bearing 44. For this reason, when the heating roller 35 rotates, stress Fd when the fixing belt 34 tries to move is given to the guide ring 40, which is provided on the right side of the drawing. The guide ring 40 is formed of a material having strength, heat resistance, and slidability. Therefore, destruction strength of the guide ring 40 and the fixing belt 34 can be increased, and abrasion in an engaging end portion of the fixing belt 34 can be minimized.

Thermal contraction of the fixing belt 34 and the heating roller 35 after printing is completed will be described with reference to FIG. 16. Immediately after the heating roller 35 stops to rotate and the fixing heater is turned off, the fixing belt 34 and the heating roller 35 having been heated start to thermally contact. The timing at which the heating roller 35 stops to rotate and the fixing heater 36 is turned off or the order in which the heating roller 35 stops to rotate and the fixing heater 36 is turned off may be appropriately selected. The heating roller 35 is restrained by the snap ring 45 and the bearing 44 on the right side of FIG. 16, and thermal contraction of the heating roller 35 acts on the restrained portion. The inner surface of the fixing belt 34 and the outer peripheral surface of the heating roller 35 are strongly held by a force Fx=belt tension×stiction force therebetween. In this state, if the heating roller 35 thermally contracts toward the restrained portion, the fixing belt 34 also moves toward the restrained portion in the same manner.

The above-described thermal expansion and thermal contraction of the heating roller 35 are reversible operations. For this reason, when the heating roller 35 and the fixing belt 34 having the same length thermally contract, the contraction amount of the heating roller 35 becomes larger than the contraction amount of the fixing belt 34. A difference in the contraction amount between the heating roller 35 and the fixing belt 34 is given as stress Ft on the right side of FIG. 16, such that the fixing belt 34 bites into the guide ring 40. If stress Ft is repeatedly given, shear destruction occurs in the end portion of the fixing belt 34.

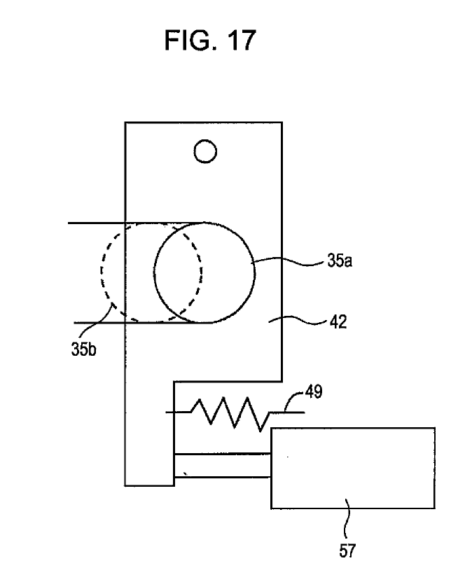

FIG. 17 shows an example of a tension release mechanism of the fixing belt according to the embodiment of the invention. In FIG. 17, reference numeral 42 denotes the tension plate described with reference to FIG. 11. A pressing force is given to a solenoid 57 in the axial direction of the heating roller 35. Reference numeral 49 denotes a tension spring. In a normal state, the spring force of the tension spring 49 acts such that one axial end of the heating roller 35 is present at a position indicated by a solid line 35a.

When thermal stress is applied to the fixing belt 34 due to an increase in temperature of the heating roller 35, the solenoid 57 operates to release the spring force of the tension spring 49, to thereby move the tension plate 42 in the left direction of the drawing. For this reason, one axial end of the heating roller 35 moves to a position indicated by the dashed line 35b. Accordingly, the intercenter distance between the fixing roller 31 and the heating roller 35 described with reference to FIG. 10 is shortened, and tension of the fixing belt 34 is reduced. As described above, the solenoid (electromagnetic driving unit) 57 and the tension spring (spring unit) 49 function as a belt tension adjusting unit.

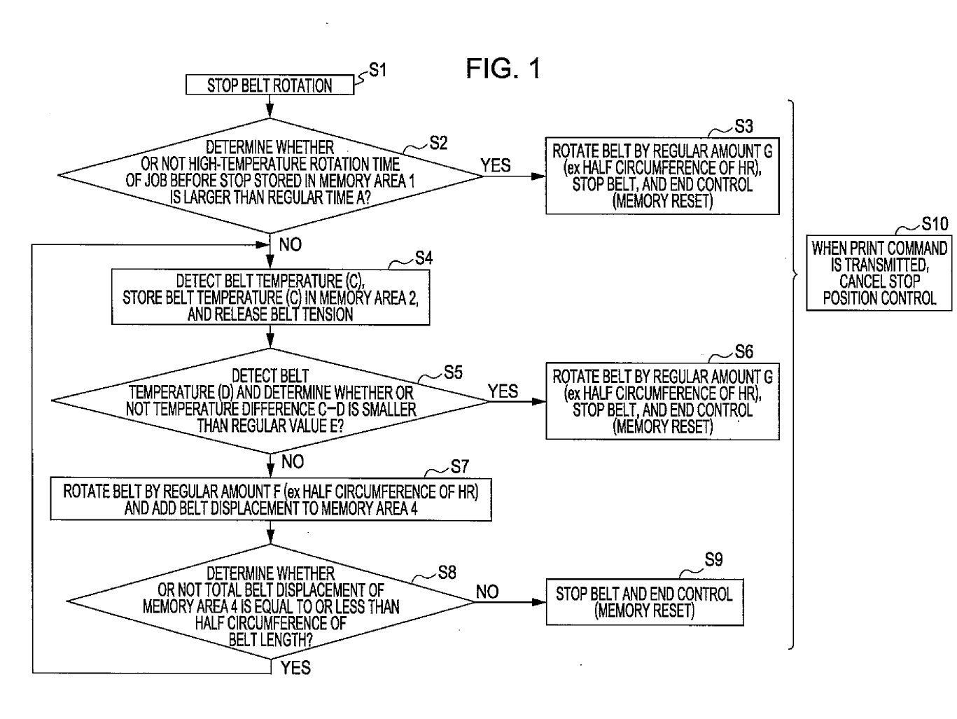

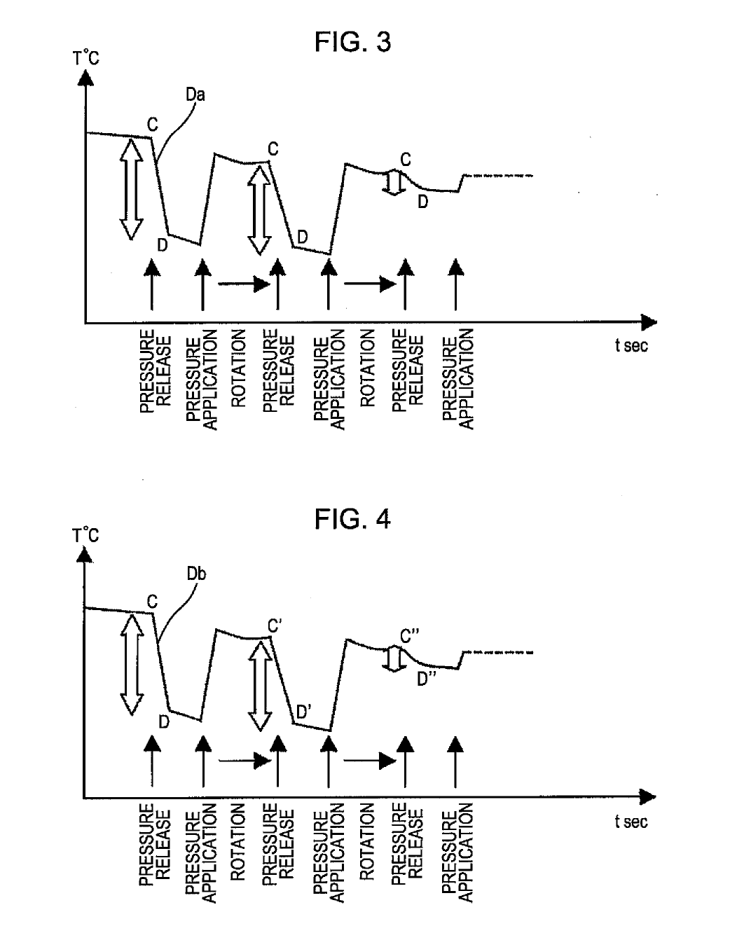

Next, the embodiment of the invention will be described with reference to flowcharts of FIGS. 1 and 2 and characteristic diagrams of FIGS. 3 and 4. The flowchart of FIG. 1 corresponds to the characteristic diagram of FIG. 3, and the flowchart of FIG. 2 corresponds to the characteristic diagram of FIG. 4. The procedure of FIG. 1 is executed as follows.

S1: The fixing belt 34 stops to rotate.

S2: It is determined whether or not a high-temperature rotation time during a job before the fixing belt 34 stops, which is stored in a memory area 1 of a storage unit, is larger than a regular time A.

S3: When the result is determined to be Yes in S2, the fixing belt 34 is rotated by a regular amount G (for example, the half circumference of the heating roller) and stops, and control of the fixing belt 34 ends to reset the memory.

S4: When the result is determined to be No in S2, the temperature (C) of the fixing belt is detected and stored in a memory area 2, and belt tension is released.

S5: The temperature (D) of the fixing belt 34 is detected, and it is determined whether or not a temperature difference C−D is smaller than a regular value E.

S6: When the result is determined to be Yes in S5, the fixing belt 34 is rotated by a regular amount G (for example, the half circumference of the heating roller 35) and stops, and control of the fixing belt 34 ends to reset the memory.

S7: When the result is determined to be No in S5, the fixing belt 34 is rotated by a regular amount F (for example, the halt circumference of the heating roller 35), and the regular amount F is added to the displacement of the fixing belt 34 stored in a memory area 4, to thereby update the displacement of the fixing belt 34.

S8: It is determined whether or not the total displacement of the fixing belt 34 of the memory area 4 is equal to or less than the half circumference of the belt length of the fixing belt 34. When the result is determined to be Yes in S8 the process returns to S4, and S4 to S8 are repeatedly executed.

S9: When the result is determined to be No in S8, the fixing belt 34 stops, and control of the fixing belt 34 ends to reset the memory.

S10: In S3, S6, or S9, when a print command is transmitted to a control section, stop position control of the fixing belt 34 is cancelled.

The procedure of FIG. 2 is executed as follows.

S11: The fixing belt 34 stops to rotate.

S12: It is determined whether or not a high-temperature rotation time during a job before the fixing belt 34 stops, which is stored in a memory area 1 of a storage unit, is larger than a regular time A.

S13: When the result is determined to be Yes in S12, the fixing belt 34 is rotated by a regular amount G (for example, the half circumference of the heating roller 35) and stops, and control of the fixing belt 34 ends to reset the memory.

S14: When the result is determined to be No in S12, the temperature (C) of the fixing belt 34 is detected and stored in a memory area 2, and belt tension is released.

S15: The temperature (D) of the fixing belt 34 is detected, and a temperature difference C−D is stored in a memory area 3.

S16: The fixing belt 34 is rotated by a regular amount F (for example, the half circumference of the heating roller 35), and the regular amount F is added to the displacement of the fixing belt 34 stored in a memory area 4, to thereby update the displacement of the fixing belt 34. S17: The temperature (C′) of the fixing belt 34 is detected and stored in the memory area 2, and belt tension is released.

S18: The temperature (D′) of the fixing belt 34 is detected, and a temperature difference C′−D′ is stored in a memory area 5.

S19: It is determined whether or not a difference between the temperature difference C−D stored in the memory area 3 and the temperature difference C′−D′ stored in the memory area 5 is larger than a regular value E.

S20: When the result is determined to be Yes in S19, the fixing belt 34 is rotated by a regular amount G (for example, the half circumference of the heating roller 35) and stops, and control of the fixing belt 34 ends to reset the memory.

S21: When the result is determined to be No in S19, the fixing belt 34 is rotated by a regular amount F (for example, the half circumference of the heating roller 35), and the regular amount F is added to the displacement stored in the memory area 4. The temperature difference C′−D′ stored in the memory area 5 is written in the memory area 3. S22: It is determined whether or not the total displacement of the fixing belt 34 of the memory area 4 is equal to or less than the half circumference of the belt length of the fixing belt 34. When the result is determined to be Yes in S22, the process returns to S17, and S17 to S22 are repeatedly executed.

S23: When the result is determined to be No in S22, the fixing belt 34 stops, and control of the fixing belt 34 ends to reset the memory.

S24: In S13, S20, or S23, when a print command is transmitted to a control section, stop position control of the fixing belt 34 is cancelled.

FIG. 3 is a characteristic diagram corresponding to the flowchart of FIG. 1. In FIG. 3, the horizontal axis denotes a time (tsec), and the vertical axis denotes a temperature (T° C.). The time of the horizontal axis includes timing for belt pressure release and application of the fixing belt 34, and rotation of the fixing belt 34. C of a characteristic Da corresponds to the temperature of the fixing belt 34 at the time of stoppage described in S4 of FIG. 1. D of the characteristic Da corresponds to the temperature of the fixing belt 34 after belt tension release described in S5 of FIG. 1. In FIG. 3, as the time of the horizontal axis elapses, the stop position of the fixing belt 34 is shifted little by little to move a ruffle in the end portion of the fixing belt 34 separated from an end portion end. In this way, the fixing belt 34 is prevented from being damaged. The “ruffle” and the “end portion bend” will be described below.

FIG. 4 is a characteristic diagram corresponding to the flowchart of FIG. 2. In FIG. 4, the horizontal axis denotes a time (tsec), and the vertical axis denotes a temperature (T° C.). Similarly to FIG. 3, in FIG. 4, the time of the horizontal axis includes timing for belt pressure release and application of the fixing belt 34, and rotation of the fixing belt. C, C′, and C″ of a characteristic Db correspond to the temperature of the fixing belt 34 at the time of stoppage described in S14, S17, and the like of FIG. 2. D, D′, and D″ of the characteristic Db correspond to the temperature of the fixing belt 34 after belt tension release described in S15, S18, and the like of FIG. 2.

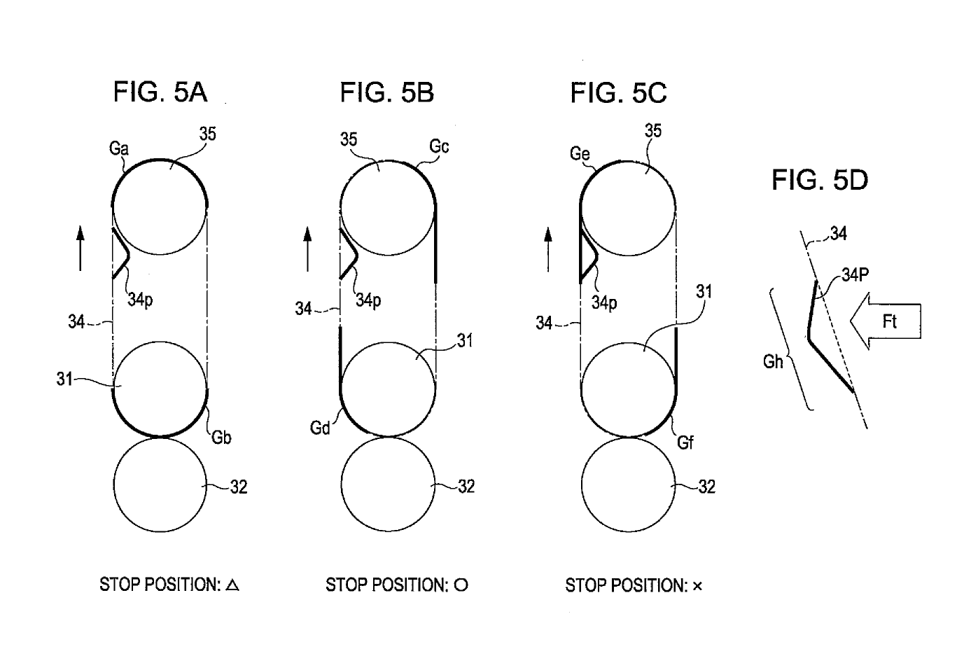

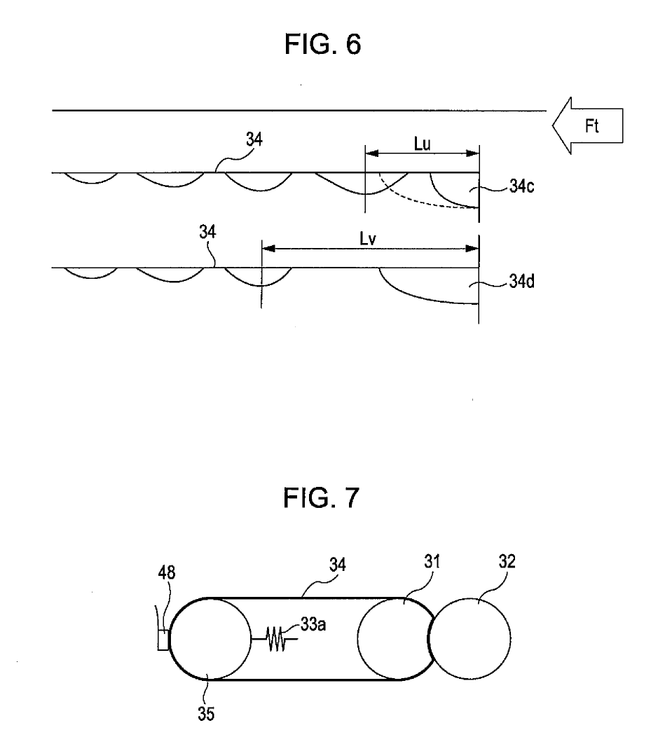

FIGS. 5A to 6 are explanatory views illustrating the embodiment of the invention. FIGS. 5A to 5D illustrate a small-curvature range in the fixing belt 34. FIG. 6 is an explanatory view illustrating the small-curvature range. As shown in FIG. 5D, if stress Ft from the guide ring 40 is applied to the end portion of the fixing belt 34, a recess 34P is formed in a range of Gh.

FIG. 6 is an explanatory view illustrating the relationship between the “ruffle” and the “end portion bend” in the fixing belt 34 when stress Ft from the guide ring 40 is applied to the end portion of the fixing belt 34. In FIG. 6, in an upper-side example, a ruffle is formed at a position Lu (a wrinkle near the end portion bend). Reference numeral 34c denotes the position of the end portion bend. If a small-curvature portion of the fixing belt 34 approaches an engagement start portion of the fixing belt 34 (a recess generation portion by the guide ring 40) in the heating roller 35, the fixing belt 34 is deformed by contraction of the heating roller 35 due to small curvature. That is, the range of the end portion bend 34c decreases, and the contraction amount of the heating roller 35 cannot be sufficiently absorbed. For this reason, a recess is formed so as to be comparatively near the end portion bend, thereby absorbing the contraction amount. Accordingly, when the fixing belt 34 restarts to be driven, two ruffles in the fixing belt 34 are connected to each other, and a crack is generated. As a result, the fixing belt 34 is damaged.

In a lower-side example of FIG. 6, a ruffle is formed at a position Lv distant from an end portion bend 34d. In this case, a small-curvature portion of the fixing belt 34 moves to a position out of an engagement start portion of the fixing belt 34 (a recess generation portion by the guide ring 40) in the heating roller. For this reason, when the fixing belt 34 restarts to be driven, two ruffles in the fixing belt 34 are not connected to each other, and thus a crack can be prevented from being generated. In the embodiment of the invention, when the fixing belt 34 has stopped, the small-curvature portion of the fixing belt moves to the position out of the engagement start portion of the fixing belt 34 in the heating roller 35, and then the fixing belt 34 is driven again. Thus, the fixing belt 34 is prevented from being damaged.

FIGS. 5A to 5C illustrate what range of the fixing belt 34 the small-curvature belt positions of the fixing belt 34 when the previous job ends are formed. In FIG. 5A, the small-curvature belt positions of the fixing belt 34 when the previous job ends are present at positions indicated by thick lines Ga and Gb. That is, the small-curvature belt positions partially rest on the engagement start portions of the fixing belt 34 (the recess generation portion by the guide ring 40) in the heating roller 35 and the fixing roller 31. For this reason, as described above, two ruffles in the fixing belt 34 may be connected to each other. As a result, such range is not appropriate as the stop position of the fixing belt 34.

In FIG. 5B, the small-curvature belt positions of the fixing belt 34 when the previous job ends are present at positions indicated by thick lines Gc and Gd. In this case, the small-curvature belt positions do not rest on the engagement start portions of the fixing belt 34 (the recess generation portion by the guide ring 40) in the heating roller 35 and the fixing roller 31. For this reason, two ruffles in the fixing belt 34 are not connected to each other. In FIG. 5C, the small-curvature belt positions of the fixing belt 34 when the previous job ends are present at positions indicated by thick lines Ge and Gf. In this case, the small-curvature belt positions rest on the engagement start portions of the fixing belt 34 (the recess generation portion by the guide ring 40) in the heating roller 35 and the fixing roller 31. For this reason, as described above, two ruffles in the fixing belt 34 are likely to be connected to each other, and thus the fixing belt 34 is likely to be damaged. As a result, such range is not appropriate as the stop position of the fixing belt 34.

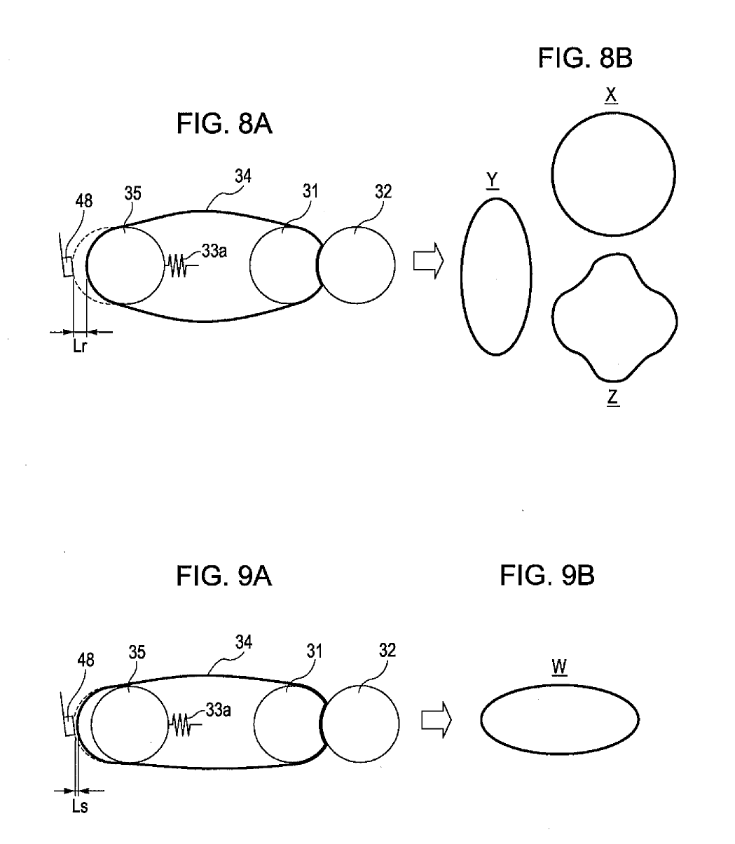

FIGS. 7 to 9B are explanatory views illustrating the embodiment of the invention. FIG. 7 illustrates the state of the belt fixing device before belt tension is released, which is the same as the example of FIG. 12. FIGS. 8A and 8B illustrate a state when belt tension is released, in which stop position control of the fixing belt 34 is not necessary. In FIG. 8A, as described above, the heating roller 35 moves from a position indicated by a dashed line to a position indicated by a solid line along the axis of the fixing roller 31. In this case, the fixing belt 34 moves to follow the outer circumference of the fixing roller 31.

The sectional shape of the fixing belt 34 is normally a circle, an ellipse, and a cross, like (X), (Y), and (Z) of FIG. 8B. If belt tension is released, the fixing belt 34 returns to the original shape. In the example of FIGS. 8A and 8B, it is determined that thermal deformation (creep) does not occur in the fixing belt 34. Such determination can be made when the sensor 48 detecting the surface temperature of the fixing belt 34 is separated from the surface of the fixing belt 34, and thus the detection temperature is lowered.

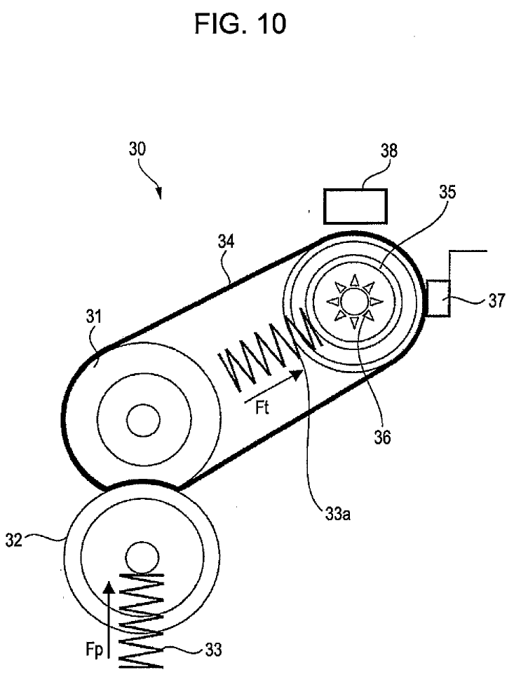

FIGS. 9A and 9B illustrate an example where stop position control of the fixing belt 34 is necessary when belt tension is released. In FIG. 9A, while the heating roller 35 moves from a position indicated by a dashed line to a position indicated by a solid line along the fixing roller 31, the fixing belt 34 does not move to follow the heating roller 35. That is, as shown in FIG. 9B, the shape (W) of the fixing belt 34 does not return to the original shape shown in FIG. 8B. In such a case, it is determined that thermal deformation (creep) occurs in the fixing belt 34. Such determination is made when the sensor 48 detecting the surface temperature of the fixing belt 34 is in contact with the surface of the fixing belt 34, and the detection temperature is not lowered. In the embodiment of the invention, the magnitude of the curvature of the fixing belt 34 is defined by an arc along a major axis of the fixing belt 34 and an arc along a minor axis of the fixing belt 34. As shown in FIG. 9B, when creep occurs in the fixing belt 34, the elliptical arc along the major axis is set so as to have small curvature, and the arc along the minor axis is set so as to have large curvature.

In the embodiment of the invention, the belt fixing device has the following structural features: (1) a mechanism releasing tension of the fixing belt 34; (2) when tension of the fixing belt 34 is released, a predetermined spacing between the heating roller 35 and the sensor 48; (3) a memory storing the rotation time of the fixing belt 34 before stoppage and the stop time of the fixing belt 34; (4) a memory storing the temperature of the fixing belt 34, or the temperature difference; and (5) a memory storing the total belt displacement of the fixing belt 34 after stop position control starts.

In the embodiment of the invention, control of the fixing belt 34 is performed as follows.

(1) Timing to detect the state of creep of the fixing belt 34, to thereby control the stop position of the fixing belt 34

1) The timing is set to be when the high-temperature (for example, a standby temperature or more) rotation time during a previous job is equal to or more than a predetermined time A (for example, 30 sec) after the fixing belt 34 has stopped to rotate. When the predetermined time is equal to or more than A, the fixing belt 34 is rotated by the regular amount G and stops.

a) When a print command is transmitted during stop position control of the fixing belt 34, stop position control is cancelled.

b) Even though power supply is cut off before transition to a sleep (power saving) mode, stop position control of the fixing belt 34 is possible.

2) At the time of transition to the sleep mode, if the sum of the high-temperature rotation time and the high-temperature stop time during the previous job is equal to or less than a predetermined time B (where B>A, for example, 15 min), a) when a print command is transmitted during stop position control, stop position control is cancelled, or b) when power supply is cut off before transition to the sleep (power saving) mode, stop position control is cancelled.

In this case, the rotation time of the fixing belt 34 can be comparatively reduced.

(2) Method of detecting the creep position and deciding the stop position of the fixing belt 34

1) The temperature C of the fixing belt 34 is checked, and belt tension is released.

2) The temperature D of the fixing belt 34 is checked, and it is checked whether or not the temperature difference (C−D) is a predetermined value E (for example, creep is small at a temperature of 10° C. or more (instead of the temperature difference C−D, the variation ((C−D)−(C′−D′)) of the temperature difference may be used).

3) Tension is given to the fixing belt 34, and the fixing belt 34 is rotated by a predetermined amount F (for example, the half circumference of the heating roller 35) (the rotation amount is the length of the fixing belt 34 wound around the heating roller 35 and is also set depending on detection accuracy or detection time).

4) 1) to 3) are repeatedly executed (when the fixing belt is stretched between two rollers having the same diameter, the half circumference of the fixing belt 34 to the maximum).

5) When it is detected that the temperature difference (C−D) is equal to or less than the predetermined value E (the fixing belt 34 does not follow. That is, creep is large), tension is given to the fixing belt 34, and the fixing belt 34 is rotated by a regular amount G (for example, the half circumference of the heating roller 35) and stops to perform stop position control.

6) When the displacement of the fixing belt 34 is the half circumference, if the temperature difference (C−D) is equal to or less than the predetermined value E, it is determined that creep is small, and stop control ends.

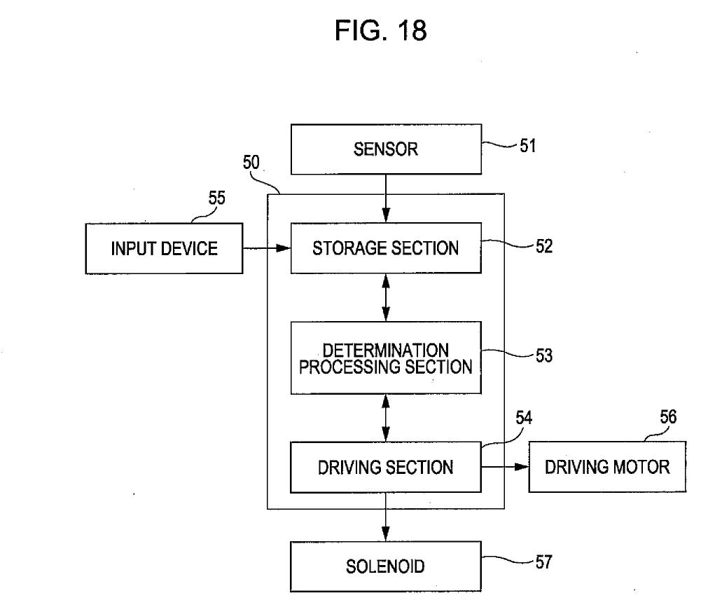

FIG. 18 is a block diagram illustrating the embodiment of the invention. In FIG. 18, a control device 50 of the belt fixing device has a sensor 51, a storage section 52, a determination processing section 53, and a driving section 54. An input device 55 inputs, for example, the length in the axial direction of the fixing belt 34 or the heating roller 35, and the belt displacement, that is, the lean of the fixing belt 34 along the axis of the roller described with reference to FIG. 15. The belt displacement may be detected in advance by imaging the fixing belt 34 with a CCD camera (not shown). Input information from the input device 55 is stored in the storage section 52. The sensor 51 detects the temperature of the fixing belt 34, and the measurement value is stored in the storage section 52. The sensor 51 corresponds to the temperature detection device 37 for turning on/off the fixing heater 36 of the heating roller 35 described with reference to FIG. 6, and the sensor 48 detecting the surface temperature of the fixing belt 34. In the storage section 52, the memory areas 1 to 5 storing the belt temperature or rotation time and the belt displacement described with reference to FIGS. 1 and 2 are set.

The determination processing section 53 forms a stop position signal of the fixing belt 34 on the basis of the temperature of the fixing belt 34 or the belt displacement stored in the storage section 52, and sends the stop position signal to the driving section 54. The driving section 54 controls a driving motor 56 driving the fixing roller 31 in accordance with the control signal. The driving section 54 also controls a solenoid (electromagnetic driving unit) 57. The solenoid 57 corresponds to the solenoid 57 serving as a belt tension adjusting unit described with reference to FIG. 17.

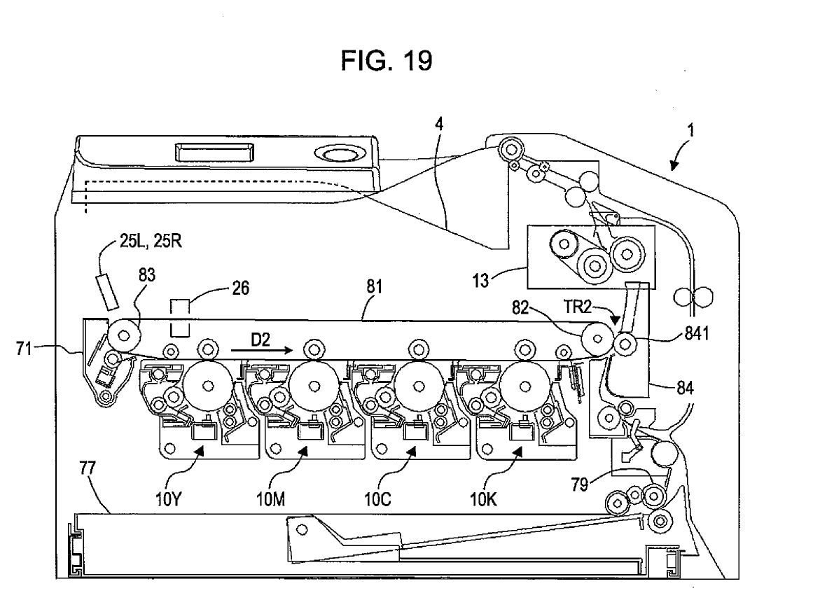

FIG. 19 is a side sectional view illustrating an example of a tandem type image forming apparatus according to the embodiment of the invention. An image forming apparatus 1 forms a color image by combining toner of four colors, for example, black (K), cyan (C), magenta (M), and yellow (Y), or forms a monochrome image only using toner of black (K). The image forming apparatus 1 is a tandem type color image forming apparatus in which four image forming stations 10Y, 10M, 10C, and 10K are arranged along an intermediate transfer belt 81, which is wound around rollers 82 and 83 and revolves in a predetermined direction D2. The image forming stations 10Y, 10M, 10C, and 10K individually store toner of yellow, magenta, cyan, and black, and form toner images of corresponding colors.

When a color image is formed, the toner images of the respective colors formed by the image forming stations are combined with each other on the intermediate transfer belt 81, thereby forming a color image on the intermediate transfer belt 81. A recording sheet, such as paper or a transparent sheet, is taken out from a sheet feeding cassette 77 one by one in accordance with rotation of a sheet feed roller 79, and is transported to a secondary transfer region TR2, which is a nip portion between a secondary transfer roller 841 and the intermediate transfer belt 81. In the above-described manner, the color image formed on the intermediate transfer belt 81 is transferred to a recording medium in the secondary transfer region TR2. The recording medium with an image transferred thereto passes through a fixing unit 13, and is discharged to a sheet discharging tray 4 in the upper portion of the image forming apparatus.

The secondary transfer roller 841 is rotatably mounted in a roller support arm 84. As occasion demands, the arm 84 pivots around a predetermined pivot shaft, and the secondary transfer roller 841 is separated from or comes into contact with the surface of the intermediate transfer belt 81. A vertical synchronization sensor 26 is provided near the roller 83 to detect the rotational phase of the intermediate transfer belt 81. The vertical synchronization sensor 26 is, for example, a photo interrupter, and detects passing of a protrusion or a cutout (not shown) provided in a portion of an edge portion of the intermediate transfer belt 81. That is, the vertical synchronization sensor 26 outputs a vertical synchronizing signal Vsync that is synchronized with the rotation cycle of the intermediate transfer belt 81.

Two position detection sensors 25L and 25R are disposed toward the surface of the intermediate transfer belt 81 wound around the roller 83 at different positions in the axial direction of the roller 83 (a direction perpendicular to the paper). The position detection sensor 25 is, for example, a reflection type photosensor, and detects presence/absence of passing of a toner image carried on the intermediate transfer belt 81 on the basis of a change in reflectance of the surface of the intermediate transfer belt 81 at a position opposite the intermediate transfer belt 81. A cleaner 71 is provided on the downstream side of the position detection sensors 25L and 25R in the movement direction of the intermediate transfer belt 81. The cleaner 71 cleans and removes residual toner stuck to the intermediate transfer belt 81. Although an example of a tandem type image forming apparatus according to the embodiment of the invention is illustrated, the invention may be applied to a rotary type image forming apparatus.

Although the belt fixing device and the image forming apparatus according to the embodiment of the invention has been described on the basis of the principle and the example, but the invention is not limited to the example. It should be noted that various modifications may be made.

The entire disclosure of Japanese Patent Application No.2008-082295, filed Mar. 27, 2008 is expressly incorporated by reference herein.

What is claimed is:

1. A belt fixing device comprising:
a fixing roller;
a heating roller;
a fixing belt stretched between the fixing roller and the heating roller;
a pressing roller pressing the fixing roller through the fixing belt; and
a temperature detection unit detecting the surface temperature of the fixing belt,
wherein in at least one end portion of the heating roller in an axial direction, a ring regulating skewed movement of the fixing belt toward an axial end, and a belt tension adjusting unit adjusting tension of the fixing belt are provided,
the temperature detected by the temperature detection unit is stored in a storage unit, and
when the belt tension adjusting unit releases belt tension, a control unit controls a rotation stop position of the fixing belt on the basis of the belt temperature stored in the storage unit.

2. The belt fixing device according to claim 1, wherein the belt tension adjusting unit adjusts a distance between the axis of the fixing roller and the axis of the heating roller by an electromagnetic driving unit and a spring unit.

3. The belt fixing device according to claim 1,
wherein control is performed such that a small-curvature portion of the fixing belt stops at a position out of an engagement start portion of the heating roller.

4. The belt fixing device according to claim 1,
wherein, in a state where the belt tension adjusting unit releases belt tension, the fixing belt maintains an ellipse when being stretched between the fixing roller and the heating roller due to thermal deformation, and small-curvature portions of the fixing belt are formed by arcs along a major axis of the ellipse.

5. The belt fixing device according to claim 1,
wherein the rotation stop position of the fixing belt is a position when tension is given to the fixing belt again after tension is released, and the fixing belt is moved from the position of the fixing belt at the time of tension release by a length of the fixing belt wound around the heating roller.

6. The belt fixing device according to claim 1,
wherein a timing to detect the state of thermal deformation of the fixing belt to control the stop position of the fixing belt is set to be when a high-temperature rotation time during a job immediately before the fixing belt stops is equal to or less than a predetermined time.

7. The belt fixing device according to claim 1,
wherein a timing to detect the state of thermal deformation of the fixing belt to control the stop position of the fixing belt is set to be when the sum of a high-temperature rotation time during a job immediately before the fixing belt stops and a stop time until a job starts is equal to or less than a predetermined time.

8. An image forming apparatus comprising:
image forming units each having at least one of a charging unit, an exposure unit, a developing unit, and a transfer unit around a photosensitive member; and
the belt fixing device according to claim 1,
wherein the image forming apparatus transfers an image formed on each of the image forming units to a recording medium, thereby performing image formation.
